(19) United States
(12) Patent Application Publication
(10) Pub. No.: US 2024/0278492 A1
(43) Pub. Date: Aug. 22, 2024

(54) SYSTEMS AND METHODS FOR CONFINED COAXIAL POWDER EXTRUSION

(71) Applicant: Lawrence Livermore National Security, LLC, Livermore, CA (US)

(72) Inventors: Maira R. CERÓN HERNÁNDEZ, Brentwood, CA (US); Hannah V. ESHELMAN, Pleasanton, CA (US); Jennifer Marie KNIPE, Oakland, CA (US); Alexandra E.L. OVERLAND, Livermore, CA (US); Michael J. TROKSA, Pleasanton, CA (US); Joshua R. DEOTTE, San Ramon, CA (US); Du T. NGUYEN, Castro Valley, CA (US)

(73) Assignee: Lawrence Livermore National Security, LLC, Livermore, CA (US)

(21) Appl. No.: 18/385,791

(22) Filed: Oct. 31, 2023

Related U.S. Application Data
(63) Continuation-in-part of application No. 18/170,362, filed on Feb. 16, 2023, now abandoned.

(51) Int. Cl. B29C 64/209; B22F 10/18; B22F 12/00; B22F 12/53; B29C 64/118; B29C 64/165; B29C 64/236; B33Y 30/00; B33Y 70/10

(52) U.S. Cl. CPC B29C 64/209; B22F 10/18; B22F 12/224; B22F 12/53; B29C 64/118; B29C 64/165; B29C 64/236; B33Y 30/00; B33Y 70/10

(57) ABSTRACT

The present disclosure relates to a system for additively manufacturing a structure for transporting carbon dioxide. The system makes use of a nozzle component having a housing. The housing has a first nozzle for receiving a powder capable of capturing carbon dioxide, and channeling the powder through the nozzle component. The housing also has a second nozzle configured to receive a polymer component and to channel the polymer through the housing without intermixing of the polymer and the powder. A print head is in communication with the housing and configured to receive both the powder and the polymer, and to co-extrude the powder and the polymer so that the polymer forms a shell that encases the powder as the powder and polymer are co-extruded.

### CROSS-REFERENCE TO RELATED APPLICATIONS

This application is a continuation-in-part and claims the benefit of U.S. application Ser. No. 18/170,362, filed on Feb. 16, 2023. The disclosure of the above application is incorporated herein by reference.

### STATEMENT AS TO RIGHTS TO APPLICATIONS MADE UNDER FEDERALLY SPONSORED RESEARCH AND DEVELOPMENT

This invention was made with Government support under Contract No. DE-AC52-07NA27344 awarded by the United States Department of Energy. The Government has certain rights in the invention.

### BACKGROUND

### Field of Endeavor

The present disclosure relates to powder extrusion and more particularly to confined coaxial powder extrusion.

### State of Technology

This section provides background information related to the present disclosure which is not necessarily prior art.

The exchange of gas into or out of a liquid continues to be a challenging problem in the absorption of gases into a solvent for industrial chemical processes, gas purification, and water purification. The potentially largest scale application is for the absorption of carbon dioxide (CO₂) for carbon capture and storage from power plants. Other applications include purification of natural gas, purification of biogas, and various industrial gas-to-liquid reactions.

The most common method for gas absorption is the use of a “packed tower” absorption column. The absorption column is typically a cylindrical reactor filled with a packing material. Liquid solvent is pumped to the top of the tower and allowed to flow down over the packing while gas is blown from the bottom of the tower in the opposite direction. The liquid solvent forms a film over the wetted parts of the packing material, resulting in a gas-liquid interface where the exchange between CO₂ and solvent takes place. A major limitation of these tower packings is that the surface-area to volume ratio of the liquid is limited by the thickness of the liquid film. This thickness is determined by the properties of the solvent but is typically around 1 mm. Additional area can be created in the tower using finer packings, but this leads to higher holdup of liquid, and impeded gas flow.

Solid sorbents are an alternative to liquid solvents in many applications, including large-scale CO₂ capture. Solid sorbents are also preferred for air purification applications for, e.g., small submarines and personal underwater rebreathers and removal of volatile organic compounds emitted from certain industrial processes. Solid sorbents include mineral CO₂ sorbents like soda-lime, designer gas sorbents like metal-organic frameworks (MOFs), zeolites, and activated carbons. Solid sorbents are typically prepared in a powder and must be pelletized or formed into monoliths with a binder, reducing accessible surface area and yielding sub-optimal gas flow.

Additive manufacturing technology is a promising new venture for forming CO₂ sorbent structures in which there have been noted time savings for production, cost savings on materials and time, and possible metamaterials applications. In particular, direct ink writing (DIW) is a microextrusion technique where a printable ink is deposited in a layer-by-layer fashion to build up an object.

Recent contemplated approaches have demonstrated the flowable nature of liquid silicone materials that may be used in a DIW process of additive manufacturing (AM) where the resulting product formed three-dimensional (3D) structures and retained their shape. Creating a formulation of a polymer ink that includes a composite sorbent has been challenging. The ink preferably has an appropriate viscosity suitable for extrusion, i.e., it must typically be viscous enough to retain its general shape and allow layer-by-layer deposition of uncured material. However, in recent approaches, inks having composite sorbent do not have the appropriate viscosity to support more than 5 layers of deposition at a time. Moreover, the water uptake and solid sorbent leaching cannot be optimized. Thus, it would be desirable to develop a manufacturing process that enables production of self-supporting structures having specific, reproducible geometries with small filament sizes (100 s of microns to millimeters) that are amenable to scaling for a commercial-scale facility.

### SUMMARY

Features and advantages of the disclosed apparatus, systems, and methods will become apparent from the following description. Applicant is providing this description, which includes drawings and examples of specific embodiments, to give a broad representation of the apparatus, systems, and methods. Various changes and modifications within the spirit and scope of the application will become apparent to those skilled in the art from this description and by practice of the apparatus, systems, and methods. The scope of the apparatus, systems, and methods is not intended to be limited to the particular forms disclosed and the application covers all modifications, equivalents, and alternatives falling within the spirit and scope of the apparatus, systems, and methods as defined by the claims.

The ability to easily and cheaply transport carbon dioxide (CO₂) from point-sources, such as power plants, to multiple potentially distant utilization sites of varying scales will enable wider utilization of captured CO₂. Applicants have developed carbonate-based composite sorbents capable of capturing, storing, transporting, and delivering CO₂ to point of use sites. Applicants have developed a Confined Coaxial Powder Extrusion (CCAPE) to increase the carbonate loading of CO₂ sorbent materials, as much as doubling the CO₂ loading capacity. Applicants have developed multiple sizes of coaxial nozzles and demonstrated extrusion of a sodium bicarbonate powder core or stainless steel powder core within a silicone shell.

The apparatus, systems, and methods are susceptible to modifications and alternative forms. Specific embodiments are shown by way of example. It is to be understood that the apparatus, systems, and methods are not limited to the particular forms disclosed. The apparatus, systems, and methods cover all modifications, equivalents, and alternatives falling within the spirit and scope of the application as defined by the claims.

### BRIEF DESCRIPTION OF THE DRAWINGS

The accompanying drawings, which are incorporated into and constitute a part of the specification, illustrate specific embodiments of the apparatus, systems, and methods and, together with the general description given above, and the detailed description of the specific embodiments, serve to explain the principles of the apparatus, systems, and methods.

FIG. 1 is an illustrative view that shows one example of an embodiment of Applicant's system.

FIG. 2 is an example of another embodiment of Applicant's system that makes use of a vibration unit.

FIG. 2a is a cross-sectional end view of the print head.

FIG. 3 is an illustrative side cross-sectional view that shows a stream which was laid down by the systems described herein, wherein the stream comprises a stream powder and a polymer, and wherein the polymer that encases the stream of powder.

FIG. 4 is an illustrative view that shows one embodiment of Applicant's Confined Coaxial Powder Extrusion (CCAPE) system.

FIG. 5 is a flow chart of an additive manufacturing system for producing Applicant's Confined Coaxial Powder Extrusion (CCAPE) system.

### DETAILED DESCRIPTION OF SPECIFIC EMBODIMENTS

Referring to the drawings, to the following detailed description, and to incorporated materials, detailed information about the apparatus, systems, and methods is provided including the description of specific embodiments. The detailed description serves to explain the principles of the apparatus, systems, and methods. The apparatus, systems, and methods are susceptible to modifications and alternative forms. The application is not limited to the particular forms disclosed. The application covers all modifications, equivalents, and alternatives falling within the spirit and scope of the apparatus, systems, and methods as defined by the claims.

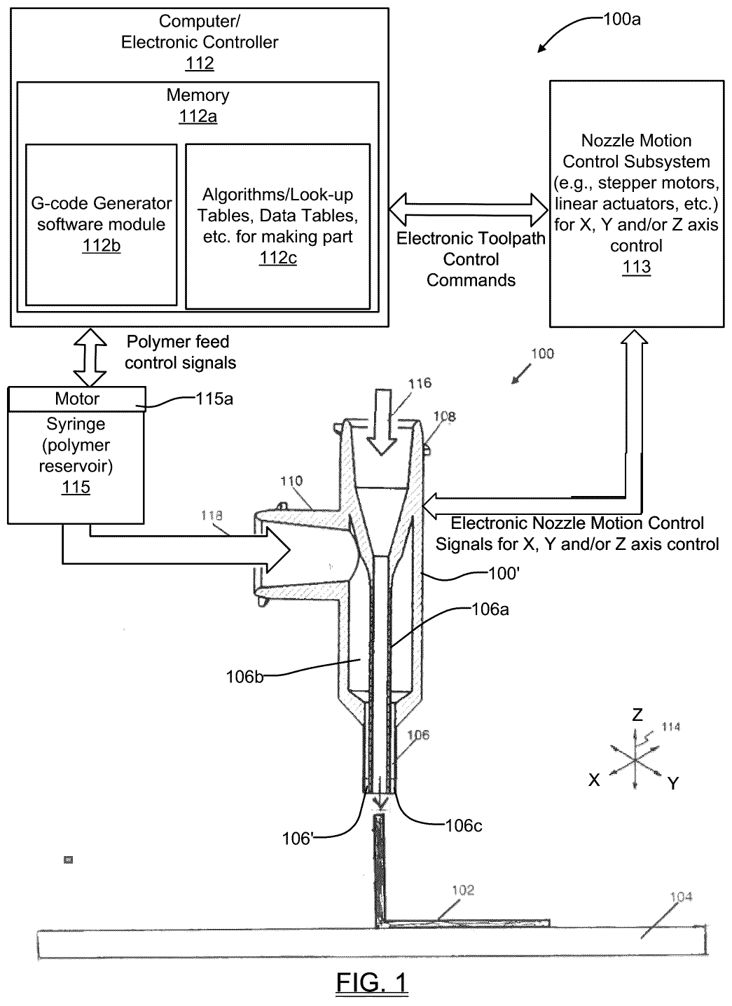

Referring now to FIG. 1, an illustrative view shows an embodiment of Applicant's apparatus, systems, and methods. This embodiment of a system in accordance with a first example is identified generally by the reference numeral 100a. The components of Applicant's system 100 as illustrated in FIG. 1 are listed below:
Reference Numeral 100a—Overall System,
Reference Numeral No. 100—nozzle component,
Reference Numeral No. 100a—housing of nozzle component,
Reference Numeral No. 102—extruded material,
Reference Numeral No. 104—printing stage,
Reference Numeral No. 106—print head,
Reference Numeral No. 106′—print head annular path,
Reference Numeral No. 106a—internal depending tubular portion within print head,
Reference Numeral No. 108—perpendicular first nozzle,
Reference Numeral No. 110—parallel second nozzle,
Reference Numeral No. 112—computer/electronic controller,
Reference Numeral No. 112a—Memory,
Reference Numeral No. 112b—G—code generator for generating tool path commands,
Reference Numeral No. 112c—Algorithms/Look—up Tables, Data Tables, etc. for making part,
Reference Numeral No. 114—X axis, Y axis and Z axis arrows,
Reference Numeral No. 116—powder, and
Reference Numeral No. 118—polymer.

The description of the components of the Applicant's system 100a having been completed, the operation and additional description of the system 100a will now be considered in greater detail. The system 100 of FIG. 1 in this example forms a Confined Coaxial Powder Extrusion (CCAPE) system that can be used to increase the carbonate loading and delivery of CO₂ to point of use sites. Applicant's CCAPE system 100 provides the ability to easily and cheaply transport carbon dioxide (CO₂) from point-sources such as, and without limitation, power plants, to multiple potentially distant utilization sites of varying scales. It is anticipated that the system 100a and the methods described herein will enable wider utilization of captured CO₂.

As illustrated in FIG. 1, extruded material 102 is deposited on a printing stage 104 by print head 106 of a nozzle component 100. The print head 106 has a first nozzle 108 which is perpendicular to a second nozzle 110. The second nozzle 110 in this example is aligned along an axis which extends generally parallel to an upper surface of the printing stage 104. However, in some embodiments, to better meet the needs of a specific printing application, the first and second nozzles 108 and 110 may not be perfectly perpendicular to another but may be offset by a predetermined number of degrees. The first nozzle 108 receives a stream of powder 116 from a powder reservoir, in one embodiment a syringe (not shown), and channels the stream of powder down through a coaxial internal tubular portion 106a of the print nozzle component housing 100′ and through the print head 106. The second nozzle 110 receives a polymer 118 from a polymer reservoir, in one embodiment a syringe (not shown) that flows into and down through an annular internal pathway 106b within the nozzle component housing 100′ and through an annular path 106′ formed in the print nozzle 106 between an external surface of the coaxial internal tubular portion 106a and an internal surface of print head 106. The polymer 118 encases the stream of powder 116 as the polymer 118 and powder exit a tip 106c of the print head 106 to form the extruded material 102.

Movement of the nozzle component 100 and its print head 106 is controlled by computer/electronic controller 112 (hereinafter simply “computer 112”) which provides electronic toolpath control commands to a nozzle motion control subsystem 113. The nozzle motion control subsystem 113 provides electronic nozzle motion control signals for controlling freedom of movement of the print head 106 along all of the X, Y and Z axes as indicated by the arrows 114. Optionally, a printing stage motion control subsystem (not shown) may be included for controlling motion of the printing stage 104 along X, Y and possibly Z axes, in place of the nozzle motion control subsystem 113. The printing stage motion control subsystem may be similar or structurally identical to the nozzle motion control subsystem 113 and may also be controlled by suitable toolpath control commands from the computer 112.

In some embodiments the computer 112 includes a memory 112a, and in some embodiments the memory 112a may be part of a fully separate component or subsystem. In either event, the memory may include a G-code generator software module 112b for generating toolpath control commands. A separate module 112c may be used to store algorithms, look-up tables, data tables, performance curves, etc. that are helpful or required for controlling the printing process being carried out by the CCAPE 100a. In one embodiment the toolpath commands used to create the product being made with the system 100a may be generated using a separate remote subsystem (not shown) having a G-code generator software module 112b and then fed to the computer 112. The computer 112 uses the G-code instructions to generate the nozzle motion control signals which are applied to the nozzle motion control subsystem 113. The nozzle motion control signals cause the nozzle component 100 and its associated print head 106 to be moved through a series of movements in one or more, or all, of the X, Y and Z axes, along the printing stage 104, thus laying down the extruded material 102 forming the product to be created by the system 100a. In other embodiments the computer 112 uses its own G-code generator software module 112b to generate the toolpath commands in response to receipt of a data file of the part to be constructed.

Referring further to FIG. 1, in some embodiments a syringe 115 may be used to form a reservoir for the polymer. A motor 115a may be associated with the syringe (e.g., with a plunger within the syringe) and used to force the polymer 118 out from the syringe 115 and into the nozzle port 110. In some embodiments the controller 112 may supply electronic feed control signals to the motor 115a such that the polymer 118 can be fed into the flow nozzle 108 at a desired feed flow rate and/or under a desired pressure. Those skilled in the art will recognize that the motor 115a is only one means for assisting in supplying the polymer 118, and that other components (e.g., linear actuator) may be used in place of a motor. Accordingly, the present disclosure is not limited to any specific means for controlling the rate of flow of the polymer from the polymer reservoir 115.

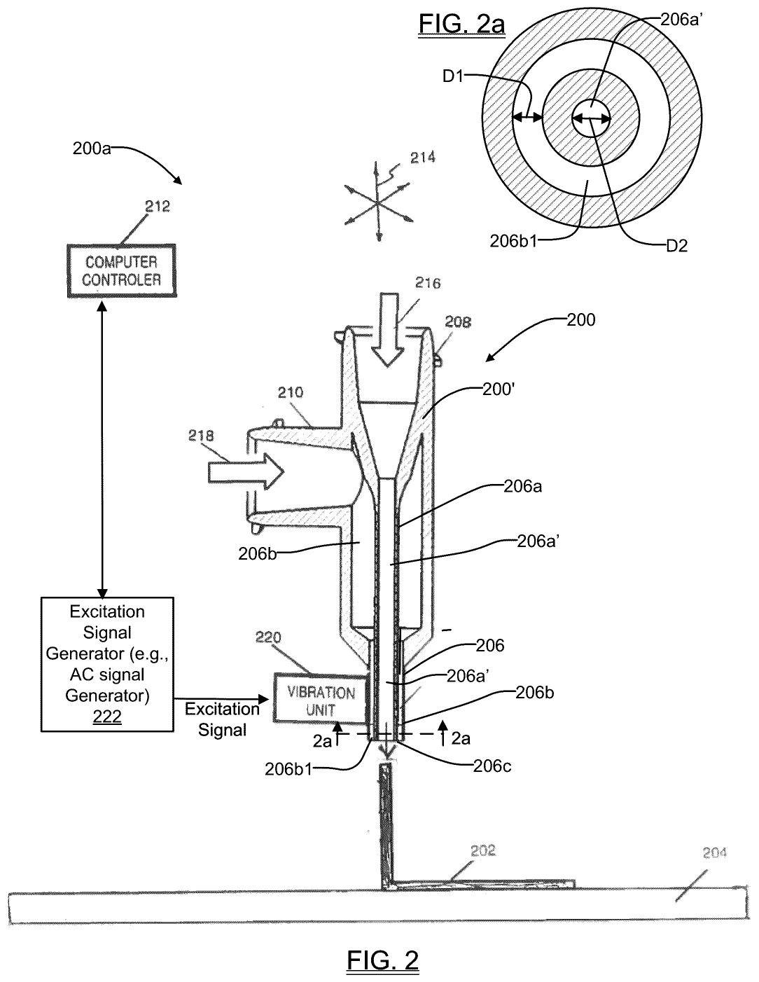

Referring now to FIG. 2, an illustrative view shows another embodiment of Applicant's apparatus, systems, and methods. The system representing this embodiment is identified generally by the reference numeral 200a. The components of system 200a are listed below, however, counterpart components to the components 112b, 112c and 113 are not shown in FIG. 1, with it being understood that in some embodiments these components will be present and used with the system 200a as well. The components of the system 200a are:
Reference Numeral No. 200a—system,
Reference Numeral No. 200—nozzle component,
Reference Numeral No. 200′—housing of nozzle component,
Reference Numeral No. 202—extruded material,
Reference Numeral No. 204—printing stage,
Reference Numeral No. 206—print head,
Reference Numeral No. 206a—internal depending tubular portion in nozzle component housing,
Reference Numeral No. 206a′—internal flow bore of depending tubular portion within print head,
Reference Numeral No. 206b—annular channel for polymer,
Reference Numeral No. 206b1—annular channel flow path for polymer within the print head,
Reference Numeral 206c—tip of print head,
Reference Numeral No. 208—perpendicular first nozzle,
Reference Numeral No. 210—parallel second nozzle,
Reference Numeral No. 212—computer controller,
Reference Numeral No. 214—arrows,
Reference Numeral No. 216—powder,
Reference Numeral No. 218—polymer,
Reference Numeral No. 220—vibration unit, and
Reference Numeral NO. 222—excitation signal generator.

The description of the components of the system 200a having been completed, the operation and additional description of the system 200a will now be considered in greater detail. The system 200a of FIG. 2 is also a CCAPE system that can be used to increase the carbonate loading and delivery of CO₂ to point of use sites. The system 200a provides the ability to easily and cheaply transport carbon dioxide (CO₂) from point-sources such as, and without limitation, power plants, to multiple potentially distant utilization sites of varying scales. As such, the system 200a is also anticipated to enable wider utilization of captured CO₂.

As illustrated in FIG. 2, extruded material 202 is deposited on a printing stage 204 by the print head 206 of the nozzle component 200. The nozzle component 200 has a housing 200′ which includes a perpendicular first nozzle 208 and a parallel second nozzle 210. Again, in this example the nozzles 208 and 210 are perpendicular to one another, but they need not be. In some embodiments the second nozzle 210 will be non-perpendicular to the first nozzle 208. In the particular example shown in FIG. 2, the second nozzle 218 is parallel to the upper surface of the printing stage 204 (i.e., build table), although it need not be configured perfectly parallel. The first nozzle 208 receives a stream of powder 216 from a powder reservoir, in one embodiment a syringe (not shown), and channels the stream of powder 216 down through an internal bore 206a′ of a depending tubular portion 206a within the nozzle housing 200′, and through the print head 206. The second nozzle 210 receives a polymer 218 from a polymer reservoir, in one embodiment a syringe (such as syringe 115 shown in FIG. 1) that flows into an annular channel 206b in the nozzle housing 200′ that circumscribes the depending tubular portion 206a. The polymer 218 flows down through the annular channel 206b and through an annular path 206b1 in the print head 206 which is formed between an external surface of the depending annular portion 206′ and an internal surface of the print head 206. Both the powder 216 and the polymer 218 exit a tip 206c of the print head 206 where the polymer 218 encases the stream of powder 216 to form the extruded material 202.

With brief reference to FIG. 2a, a cross-sectional end view of the print head 206 is shown. Dimension D1 represents the radial width of the annular flow 206b1 within at the nozzle tip 206c. This dimension may vary considerably depending on the viscosity of the polymer and other factors, but in some embodiments is between about 50 μm-2000 μm. Dimension D2 is the internal diameter of the depending tubular portion 206a. Dimension D2, in some embodiments, may be between about 100 μm-2000 μm in diameter. Those skilled in this art will appreciate that this dimension may also vary considerably depending on a number of factors including the type of powder being used, the diameter of the particles forming the powder, and other factors.

As part of the system 200a, or optionally as a fully separate component, a vibration unit 220 is included along with an excitation signal generator 222. The vibration unit 220 in some embodiments may be operatively connected to the print head 206 or to a syringe (not shown) which is connected to the first nozzle 208 containing the powder 216. An example of the vibration unit 220 is a vibration assisted powder extrusion (VAPE) system that could consist of a Troll Mini-Vibration Speaker connected to the syringe containing the powder. Another example of the vibration unit is a multistack piezoelectric ring element and a collar 220a for attachment to the print head 206. When an excitation signal, for example a sinusoidal voltage, is applied to the piezoelectric ring element from the excitation signal generator 222, the piezoelectric ring element displaces axially, which causes a vibrational force to translate to print head 206 and the powder medium 216. This translated vibrational force enables powders in a jammed state to flow out of the print head 206 onto the printing stage 204.

In some embodiments the inner diameter of the depending tubular portion 206a where it terminates at the tip 206c may be between about 100 μm-2000 μm. In some embodiments the radial distance of the annular channel 206b at the tip, as marked by reference numeral 206b1, may be between about 50 μm-2000 μm. These dimensions may vary significantly depending upon the specific powder 216 being used, as well as the specific

Movement of the print head 206 is controlled in some embodiments by computer 212 which provides freedom of movement along all X, Y and/or Z axes as indicated by the arrows 214. The computer 112 of the system 200a in some embodiments may receive G-code from an external G-code generator software subsystem (not shown) or alternatively may generate the G-code from a G-code generator software module associated with the computer (i.e., such as G-code generator software module 112b for system 100a). In either instance, the G-code is used by the computer 212 to generate the print head 206 electronic motion control signals which control motion of the print head along the X, Y and Z axes as needed to print product. The electronic motion control signals are used to move the print head 206 through a series of movements along the printing stage 204 along the needed X, Y and/or Z axes to lay down the extruded material 202 forming the product to be created by the system 200a.

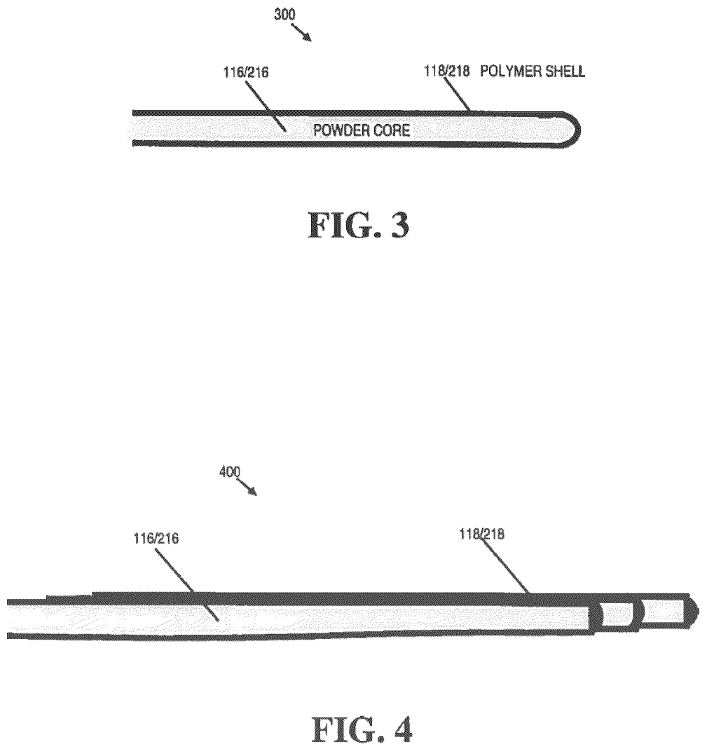

Referring now to FIG. 3, an illustrative cross-section view is presented that shows a stream of powder and a polymer which may be formed using either of the systems 100a or 200a, and wherein the stream of polymer encases the stream of powder to form an extruded product 300. The components of the extruded product 300 are listed below:
Reference Numeral No. 116/216—powder, and
Reference Numeral No. 118/218—polymer shell.

The description of the components of the extruded product 300 having been completed, the additional description of the extruded product 300 will now be considered in greater detail. A stream of powder 116/216 and a polymer 118/218 encases the stream of powder 116/216. The powder 116/216 can be a carbonate-based composite sorbent capable of capturing CO₂. The polymer layer 118/218 can be a thermally curable silicone, for example and without limitation, SE1700, 3M Auto Silicone, DMS-V33, or Sylgard 184. In some embodiments a combination of two or more of the just-mentioned thermally curable silicone components may be used.

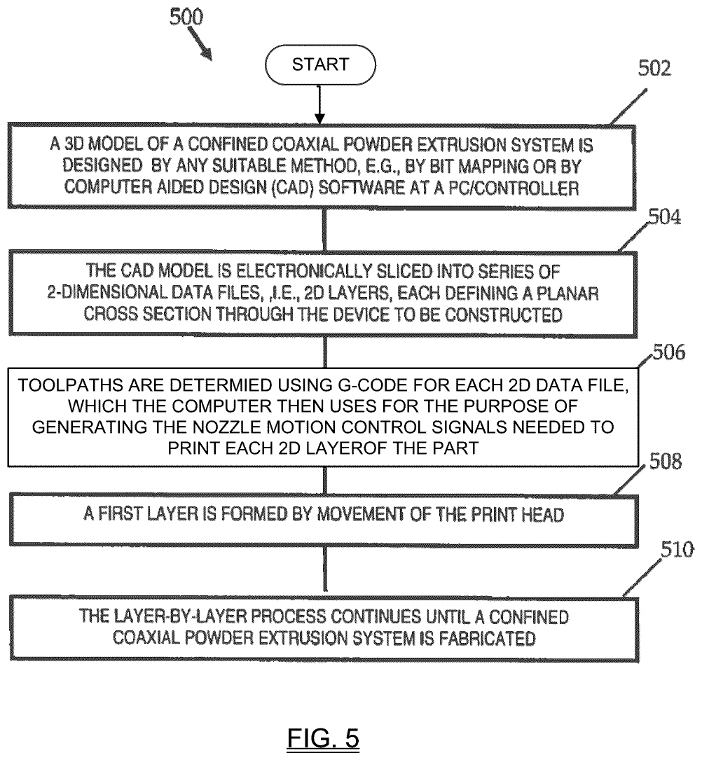

Referring now to FIG. 4, a cross-sectional side view of a stream 400 is shown that can be produced by the system 100a or 200a and used to increase the carbonate loading and delivery of CO₂ to point of use sites. The stream 400 can be produced by a direct ink write additive manufacturing process using the systems 100a or 200a. As illustrated in FIG. 4, a core of powder 116/216 is provided, and a polymer 118/218 encases the powder core 116/216. The powder 116/216 can be a carbonate-based composite sorbent capable of capturing CO₂. The polymer layer 118/218 can be a thermally curable silicone, for example and without limitation, SE1700, 3M Auto Silicone, DMS-V33, or Sylgard 184. In some embodiments a combination of two or more of the just-mentioned thermally curable silicone components may be used.

Referring now to FIG. 5 a flow chart 500 is shown illustrating one example of operations or steps that may be performed in carrying out a method of the present disclosure.

Step 502—a 3D model of a part to be made using the Applicant's Confined Coaxial Powder Extrusion (CCAPE) system 100a, 200a is designed by any suitable method, e.g., by bit mapping or by computer aided design (CAD) software at a PC/controller.

Step 504—the CAD model is electronically sliced into series of 2-dimensional data files, i.e., 2D layers, each defining a planar cross section through the device to be constructed.

Step 506—the series of 2-dimensional data files, i.e., 2D layers, each define a planar cross section through the device to be constructed, and G-code is used to generate the toolpaths needed to print each specific layer, with the computer then using the G-code to help determine the nozzle motion control signals needed to control motion of the print head as needed to print each 2D layer.

Step 508—the nozzle motion control subsystem uses the motion control signals generated by the computer to move the print head relative to the support surface and to print a first layer of the part, and

Step 510—the layer-by-layer process continues until the part is fully printed and complete.

Therefore, it will be appreciated that the scope of the present application fully encompasses other embodiments which may become obvious to those skilled in the art. In the claims, reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device to address each and every problem sought to be solved by the present apparatus, systems, and methods, for it to be encompassed by the present claims. Furthermore, no element or component in the present disclosure is intended to be dedicated to the public regardless of whether the element or component is explicitly recited in the claims. No claim element herein is to be construed under the provisions of 35 U.S.C. 112, sixth paragraph, unless the element is expressly recited using the phrase “means for.” Still further, use of the term “about” herein indicates a range of +10% to −10% from an indicated value.

While the apparatus, systems, and methods may be susceptible to various modifications and alternative forms, specific embodiments have been shown by way of example in the drawings and have been described in detail herein. However, it should be understood that the application is not intended to be limited to the particular forms disclosed. Rather, the application is to cover all modifications, equivalents, and alternatives falling within the spirit and scope of the application as defined by the following appended claims.

1. A system for additively manufacturing a structure for transporting carbon dioxide, the system comprising:
a nozzle component including:
a housing having:
a first nozzle formed on the housing for receiving a powder capable of capturing carbon dioxide, and channeling the powder through the nozzle component;
a second nozzle formed on the housing and configured to receive a polymer component and channeling the polymer through the housing without intermixing of the polymer and the powder; and
a print head in communication with the housing and configured to receive both the powder and the polymer, and to co-extrude the powder and the polymer so that the polymer forms a shell that encases the powder.

2. The system of claim 1, wherein the housing includes an internal depending tubular portion extending coaxially through the housing and through the print head.

3. The system of claim 1, wherein the print head includes an annular path for channeling the polymer out therefrom.

4. The system of claim 1, further comprising a vibration unit configured to provide a vibration energy to the print head.

5. The system of claim 4, further comprising an excitation signal generator configured to provide an excitation signal to the vibration unit.

6. The system of claim 5, further comprising a computer configured to control the excitation signal generator.

7. The system of claim 1, further comprising a nozzle motion control subsystem configured to control motion of the nozzle component along X and Y axes.

8. The system of claim 7, further comprising a computer in communication with the nozzle motion control subsystem and configured to provide electronic toolpath commands to the nozzle motion control subsystem for controlling motion of the nozzle component.

9. The system of claim 1, further comprising the polymer, and wherein the polymer.

10. The system of claim 9, wherein the polymer comprises a carbonate-based composite sorbent capable of capturing carbon dioxide.

11. The system of claim 9, wherein the polymer comprises a thermally curable polymer.

12. The system of claim 1, further comprising the powder.

13. The system of claim 12, wherein the powder comprises bicarbonate-based powder.

14. The system of claim 12, wherein the powder comprises stainless steel powder.

15. The system of claim 12, wherein the powder comprises at least one of:
a metal organic frameworks (MOF) powder core;
a metal-organic frameworks (MOFs);
a zeolite; or
an activated carbon.

16. A system for additively manufacturing a structure for transporting carbon dioxide, the system comprising:
a nozzle component including:
a housing having:
a first nozzle formed on the housing for receiving a powder capable of capturing carbon dioxide;
an internal depending tubular portion in communication with the first nozzle for channeling the powder through the nozzle component, the internal depending tubular portion being aligned coaxially with a longitudinal axis extending through the housing;
a second nozzle formed on the housing non-parallel to the first nozzle and configured to receive a polymer component;
an annular flow path formed around an exterior of the internal depending tubular portion for channeling the polymer through the housing without intermixing of the polymer and the powder; and
a print head in communication with the housing and configured to receive both the powder and the polymer, and to co-extrude the powder and the polymer so that the polymer forms a shell that encases the powder as the powder and the polymer are extruded from the print head.

17. The system of claim 16, further comprising a vibration unit for generating a vibration signal which is applied to the print head to assist in extruding the powder through the print head.

18. The system of claim 17, further comprising an excitation signal generator in communication with the vibration unit and configured to generate an excitation signal which is applied to the vibration unit to control the vibration unit.

19. The system of claim 16, further comprising:
a computer; and
a nozzle motion control subsystem in communication with the computer for receiving toolpath commands, and generating signals for controlling movement of the nozzle component along at least one of X, Y and Z axes.

20. A method for additively manufacturing a structure for transporting carbon dioxide, the method comprising:
channeling a powder as a first stream through a first port into a first flow path in a housing of a nozzle component, the powder able to capture carbon dioxide;
simultaneously channeling a polymer component as a second stream through a second port of the housing and through an annular second flow path in the housing which surrounds the first flow path; and
receiving the first stream of the powder and the second stream of the polymer component in a print head and co-extruding the first and second streams such that the polymer component encases the powder as the first and second streams are depositing on a printing stage.
